(19) United States
(12) Patent Application Publication
(10) Pub. No.: US 2020/0353457 A1
(43) Pub. Date: Nov. 12, 2020

(54) FLUID EJECTION DEVICES WITH IONIZERS COUPLED TO EJECTION HEAD INTERFACES

(71) Applicant: HEWLETT-PACKARD DEVELOPMENT COMPANY, L.P., Spring, TX (US)

(72) Inventors: Dennis R. ESTERBERG, Corvallis, OR (US); Christie DUDENHOEFER, Corvallis, OR (US)

(73) Assignee: HEWLETT-PACKARD DEVELOPMENT COMPANY, L.P., Spring, TX (US)

(21) Appl. No.: 16/766,164

(22) PCT Filed: Jan. 30, 2018
(86) PCT No.: PCT/US2018/015834

§ 371 Date: May 21, 2020

(51) Int. Cl. B01L 3/02

(52) U.S. Cl. CPC B01L 3/0268; B01L 2400/0415; B01L 2400/0487

(57) ABSTRACT

In one example in accordance with the present disclosure, a fluid ejection device is described. The fluid ejection device includes a vertical support and an interface movably coupled to the vertical support. The interface is to receive an ejection head. The fluid ejection device also includes an ionizer coupled to the interface to electrostatically neutralize a substrate.

### BACKGROUND

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluid ejection device with an ionizer coupled to an ejection head interface, according to an example of the principles described herein.

FIG. 2 is a block diagram of a fluid ejection system including a fluid ejection device with an ionizer coupled to an ejection head interface, according to an example of the principles described herein.

FIG. 3 is an isometric view of the fluid ejection system including a fluid ejection device with an ionizer coupled to an ejection head interface, according to an example of the principles described herein.

FIGS. 4A and 4B are isometric views of an interface cover with an incorporated ionizer, according to an example of the principles described herein.

FIG. 5 is a flowchart showing a method for simultaneously ejecting fluid and electrostatically discharging a substrate, according to an example of the principles described herein.

FIG. 6 is a flowchart showing a method for simultaneously ejecting fluid and electrostatically discharging a substrate, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

Such assays have been performed manually. That is, a user fills fluid into a single channel pipette, or a multi-channel pipette, and manually disperses a prescribed amount of fluid from the pipette into various wells of a titration plate. As this process is done by hand, it is tedious, complex, and inefficient. Moreover, it is prone to error as a user may misalign the pipette with the wells of the titration plate and/or may dispense an incorrect amount of fluid. Still further, such manual deposition of fluid may be incapable of dispensing low volumes of fluid, for example in the picoliter range,

In some examples however, digital dispensing of fluid is replacing manual dispensing methods. In these examples, high precision digital fluid ejection devices, referred to herein as fluidic dies, are used. A fluidic die includes a number of ejection subassemblies. Each ejection subassembly holds a small volume of fluid and an actuator expels that fluid through an opening. In operation, the fluidic dies dispense the fluid onto a substrate, such as into wells of a titration plate positioned below the fluidic dies. A fluidic ejection system holds the fluidic dies and the substrate. This fluidic ejection system controls fluid ejection from the fluidic dies onto the substrate. As part of this, the fluidic ejection system may properly position the fluidic dies with respect to the substrate by moving either the fluidic dies or the substrate.

While fluidic ejection devices have undoubtedly advanced digital titration, some characteristics impede their more complete implementation. For example, certain fluid ejection systems include an ionizing station where the substrate on which fluid is to be deposited may be electrostatically neutralized. An ionizing station may be separate from an overall fluid ejection system. Such separate systems may significantly increase the cost, complexity, and time needed to prepare for, and deposit the fluid on the substrate.

Accordingly, the present specification describes a fluidic ejection system that addresses these and other issues, Specifically, the present specification describes a fluidic ejection device and system that include an ionizer coupled to the interface where an ejection head is installed. Accordingly, the ionizer can electrostatically discharge the substrate at the same time, or immediately before the fluid is deposited onto the substrate.

Specifically, the present specification describes a fluid ejection device. The fluid ejection device includes a vertical support and an interface movably coupled to the vertical support. The interface is to receive an ejection head. The fluid ejection device also includes an ionizer coupled to the interface to electrostatically neutralize a substrate.

The specification also describes a fluid ejection system. The fluid ejection system includes a base and a substrate stage movably coupled to the base. The fluid ejection system also includes a fluid ejection device with its corresponding vertical support, interface, and ionizer.

The specification also describes a method. According to the method, an ionizer coupled to an interface of a fluid ejection device electrostatically neutralizes a substrate. An ejection head disposed in the interface dispenses a fluid onto a substrate.

As used in the present specification and in the appended claims, the term “fluidic die” refers to a component that ejects fluid and includes a number of ejection subassemblies.

Accordingly, as used in the present specification and in the appended claims, the term “ejection subassembly” refers to an individual component of a fluidic die that ejects fluid onto a surface. The ejection subassembly may be referred to as a nozzle and includes at least an ejection chamber to hold an amount of fluid and an opening through which the fluid is ejected. In some examples, the ejection subassembly includes an actuator disposed within the ejection chamber.

Further, as used in the present specification and in the appended claims, the term “ejection head” refers to a component received in a fluidic ejection device that includes multiple fluidic die. In one example, an ejection head may be removably inserted into a fluidic ejection device. In another example, the ejection head may be integrated into the fluidic ejection device.

Accordingly, as used in the present specification and in the appended claims, the term “fluid ejection device” refers to a device that receives the ejection head and includes the vertical support that moves and the manual adjustment device. Specifically, an “interface” of the fluid ejection device receives the ejection head. That is, the “interface” is a component of the fluid ejection device.

As used in the present specification and in the appended claims, the term “fluid ejection system” refers to the fluidic ejection device as well as the substrate stage on which a substrate is disposed.

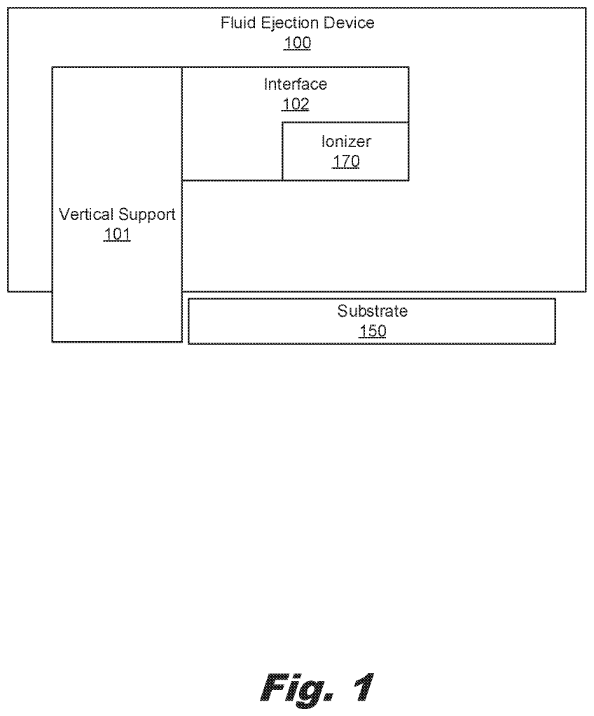

Turning now to the figures, FIG. 1 is a block diagram of a fluid ejection device (100) with an ionizer (170) coupled to an ejection head interface (102), according to an example of the principles described herein. The fluid ejection device (100) may be part of an overall fluid ejection system used to dispense fluid onto a substrate (150). For example, the fluid ejection system may dispense fluid into wells of a titration plate. The fluid dispensed by the fluid ejection device (100) may be of a variety of types. For example, the fluid ejection device (100) may dispense solvent or aqueous-based pharmaceutical compounds and aqueous-based biomolecules including, for example, proteins, enzymes, lipids, mastermix, DNA samples, among others, into wells of a titration plate or onto other types of substrates (150). Such fluid ejection systems may be used in titration processes, compound secondary screening, enzyme profiling, and polymerase chain reactions (PCR), among other chemical and biochemical reactions.

The fluid ejection device (100) includes a vertical support (101) and an interface (102) movably coupled to the vertical support (101). The interface (102) may move using any mechanism including, for example, a number of mating rails with one half of the mating rails being coupled to the vertical support (101) and the other half of the mating rails being coupled to the interface (102).

The fluid dispensing unit (100) also includes an ionizer (170) coupled to the interface (102) to electrostatically neutralize a substrate (150). In some examples the ionizer (170) if fixedly coupled to the interface (102) such that as the interface (102) moves, so does the ionizer (170).

The ionizer (170) may be any device that flows or cascades positively and negatively charged molecules, either simultaneously or alternating, over the surface of the substrate (150) to eliminate any built-up or existing charge on the substrate (150). In this example, the ionizer (170) itself creates the charged ions through its internal functions.

Because the ejection head in the interface (102) dispenses such small volumes of fluid, the flight of the fluid from the ejection head to the substrate (150) may be affected by the electrostatic charge of the substrate (150) by electrostatically attracting the dispensed fluid away from the target location on the substrate (150). Thus, in some instances where the substrate (150) is electrostatically charged, the fluid may be deposited in an unintended area of the substrate (150). In cases where the substrate (150) is a titration plate including a number of wells, the deposition of the fluid into an unintended well because of the electrostatic charge of the titration plate may have significant consequences with regard to the chemical and biochemical reactions taking place in the wells. Further, such electrostatic forces can result in the deposition of the fluid on an edge of a well instead of at the bottom of the well. In this instance, the fluids in a well may not mix well, and the intended chemical and biochemical reactions may not even take place.

Accordingly, the ionizer (170) removes any positive or negative charge from the substrate (150). Specifically, if the substrate (150) is charged positively, the substrate (150) will absorb negative ions from the ionizer (170) and repel the positive ions. When the substrate (150) becomes neutralized, there is no longer electrostatic attraction and the substrate (150) will cease to absorb ions. Conversely, if the substrate (150) is negatively charged, the substrate (150) will absorb the positive ions being generated by the ionizer (170) and repel the negative ions. Again, once neutralization is accomplished, the substrate (150) will no longer attract ions and such electrostatic charges are therefore not present to alter the fluid deposition on the substrate (150).

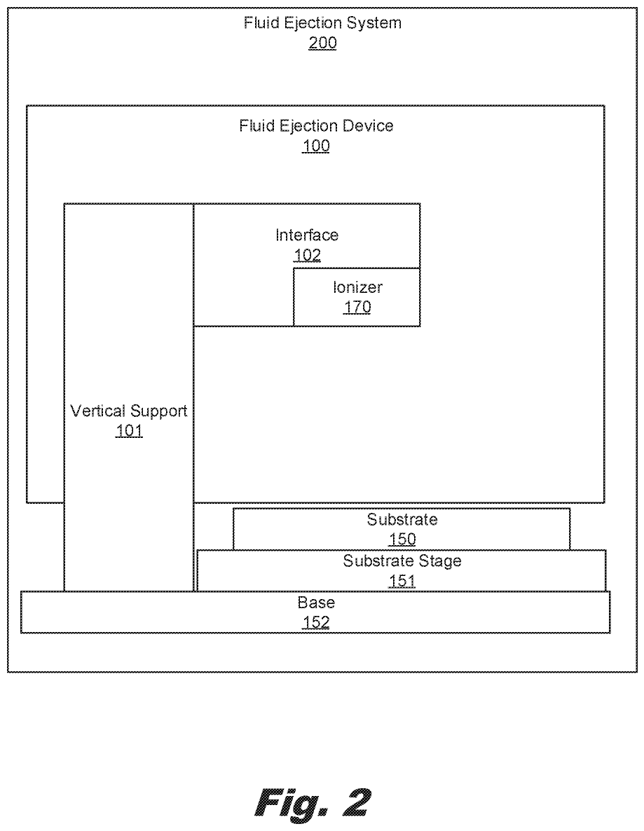

FIG. 2 is a block diagram of a fluid ejection system (200) including a fluid ejection device (100) with an ionizer (170) coupled to an ejection head interface (102), according to an example of the principles described herein. The fluid ejection system (200) includes the fluid ejection device (100) with its corresponding interface (102), vertical support (101), and ionizer (170). The fluid ejection system (200) also includes a base (152) to hold the fluid ejection device (100). In some examples, the vertical supports (101) extends from the base (152) and is movable in an x, y, and z direction relative to the base (152).

The fluid ejection system (200) also includes a substrate stage (151) that is movably coupled to the base (152). The substrate stage (151) moves as instructed by a processing device in order to place the substrate (150) into a desired position underneath the ejection head which is disposed within the interface (102).

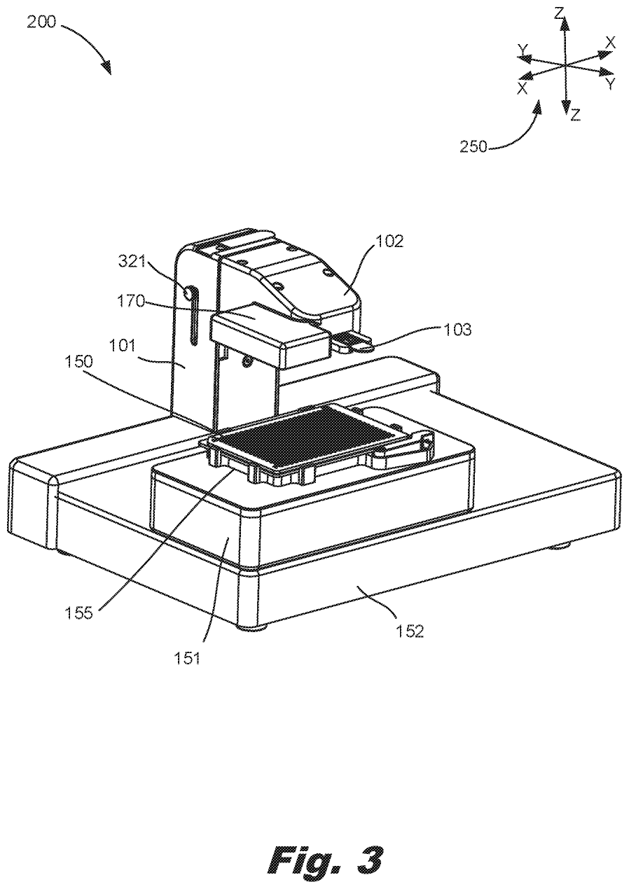

FIG. 3 is an isometric view of the fluid ejection system (200) including a fluid ejection device (FIG. 1, 100) with an ionizer (170) coupled to an ejection head interface (102), according to an example of the principles described herein. As described above, the fluid ejection system (200) includes a base (152) and a substrate stage (151) movably coupled to the base (152). That is, the substrate stage (151) may move relative to the base in an X and Y direction as indicated by the coordinate indicator (250). Such movement allows the ejection head (103) to align with, and deposit fluid onto different portions of the substrate (150).

The substrate stage (151) refers to a component that retains the substrate (150), which as depicted in FIG. 3, may be a titration plate. However, any other type of substrate (150) may be retained in the substrate stage (151). The substrate stage (151) includes a mount (155) to retain the substrate (150) in a fixed position relative to the substrate stage (151). In this manner, the substrate (150) is secured to the substrate stage (151) and remains in place during movement of the substrate stage (151) relative to the base (152) when fluid from the interface (102) is dispensed onto the various portions of the substrate (150).

Turning to the substrate (150), the substrate (150) may be any material on which fluid may be dispensed. In one example, the substrate (150) may be a titration plate with a number of wells in an array. Such a titration plate may be between approximately 4 and 50 millimeters thick. Note that while FIG. 3 depicts a titration plate as a specific example of a substrate (150), the substrate (150) may be any surface on which fluid may be deposited including, for example, a microscope slide, an edible wafer, or any other substrate. As the interface (102) is adjustable in the z direction as indicated by the coordinate indicator (250), the fluid ejection system (200) can accommodate a wide variety of substrates and media having different thicknesses.

The interface (102) provides an electrical interface to an ejection head (103). The ejection head (103) may include a number of fluidic dies on a bottom surface and a number of reservoirs on a top surface to deliver fluid to the fluidic dies. A fluidic die may include a plurality of ejection subassemblies used to eject fluid from the fluidic die. The fluidic dies may be discrete MEMSs (Micro-Electro-Mechanical Systems) where each fluidic die dispenses drops of between approximately 1.0 picoliters and 500 picoliters. The reservoirs are open at the top to receive fluid, for example from a pipette, and may have a narrower opening at the bottom to deliver the fluid to respective fluidic die on the bottom of the ejection head (103). In some examples, the ejection head (102) is removable from the fluid ejection system (200) for example as a replaceable cassette. In other examples, the ejection head (102) is integrated with the fluid ejection system (200).

The fluid ejection system (200) also includes an ionizer (170) that is fixedly coupled, and therefore moves with, the interface (102). That is, during operation, the substrate stage (151) may move relative to the base (152) to place the substrate (150) below the interface (102) in order to allow fluid to be dispensed onto the substrate (150), such an operation may be referred to as a dispense routine. At the same time as this dispense routine is performed, an ionization routine performed by the ionizer (170). In another example, the ionization may be performed by the ionizer (170) preceding the dispense routine performed by the ejection head (103).

In this example, the ionizer (170) passes over portions of the substrate (150) before the ejection head (103) coupled to the interface (102) passes over those portions of the substrate (150) and deposits fluid in the wells. In this manner, the electrostatic charge of the substrate (150) may be neutralized directly before or at least substantially directly before fluid is ejected from the ejection head (103). Thus, the proximity of the ionizer (170) to the ejection head (130) and interface (102), along with the ionizer (170) preceding the interface (102) over the substrate (150) improves the effectiveness of the ionizer (170) since there exists almost no time or possibility for the substrate (150) to be electrostatically charged between deionization of the substrate (150) and the deposition of the fluid onto the substrate (150).

Again, as depicted in FIG. 3, the interface (102) may move in the Z direction relative to the vertical support (101). Therefore, in the examples described herein, the ionizer (170) also moves with the interface (102) as the distance between the interface (102) and the substrate (150) changes. In some examples, an output of the ionizer (170) may be adjusted based on the change in distance between the interface (102) and the substrate. Accordingly, rather than moving the substrate (150) to a separate ionizing device to make the electrostatic charge of the substrate (150) neutral, the ionizer (170) may be made available at any time the fluid is to be dispensed from the interface (102).

The fluid ejection system (200) may also include a manual adjustment device to raise and lower the interface (102)/ejection head (103) and ionizer (170) relative to the substrate (150). That is, via the manual adjustment device, a user may raise and lower the interface (102) and as the ionizer (170) is fixedly coupled to the interface (102), adjustment via the manual adjustment device also raises and lowers the ionizer (170). That is, as the interface (102) moves in the z-direction so moves the ionizer (170) on account of the ionizer (170) being fixedly coupled to the interface (102).

The manual adjustment device may include any number of non-automated components such as, for example, a set screw (321)—with or without preset position indicators as depicted in FIG. 3. Other examples include a shim, a motor and gear set, and a pneumatic device to move the interface (102) relative to the substrate (150)/substrate stage (151). The manual adjustment device (150) may include other components to aid in such movement including a graphical user interface (GUI) and a toggle switch. The inclusion of the manual adjustment device reduces the cost in manufacturing and parts within the fluid ejection device (100) and the system of which it is a component. While FIG. 3 depicts a set screw (321) adjustment device other types of adjustment devices may be implemented including, but not limited to motors and gear sets and pneumatic devices.

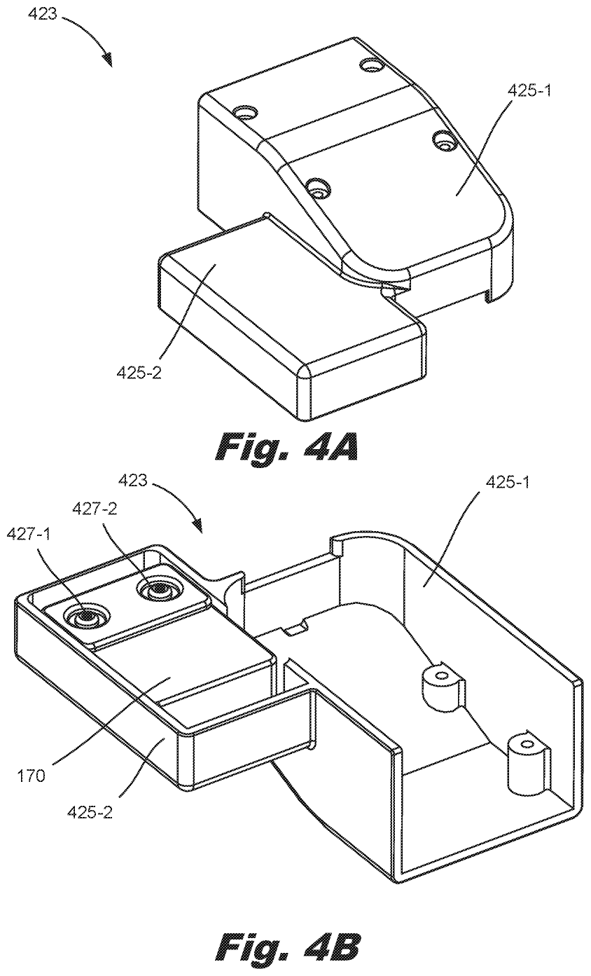

FIGS. 4A and 4B are isometric views of an interface cover (423) with an incorporated ionizer (170), according to an example of the principles described herein. Specifically, FIG. 4A depicts a top view of the interface cover (423) and FIG. 46 depicts a bottom view of the interface cover (423). The cover (423) may include a first portion (425-1) that covers or houses the interface (FIG. 1, 102). The cover (423) also includes a second portion (425-2) that covers or houses the ionizer (170). The first portion (425-1) and the second portion (425-2) may be formed into a single cover (423), or may be separate covers (423) that may be coupled to one another.

In one example, the cover (423) may be independent of the fluid ejection system (FIG. 2, 200). For example, another cover of the interface (102), for example a cover that does not include an ionizer (170) may be removed from the fluid ejection system (200) and may be replaced with the cover (423) depicted in FIGS. 4A and 4B that includes an attached ionizer (170). The cover (423) may be coupled to the interface (102) in any number of ways including using a number of screws, other fasteners, or a snap fit.

As depicted in FIG. 4B, the ionizer (170) is coupled to the underside of the second portion (425-2) using a number of screws (427-1, 427-2) or other fasteners. The ionizer (170) may be electrically coupled to the fluid ejection system (FIG. 2, 200) in order to provide electrical power to the ionizer (170) for use in neutralizing the electrostatic charge of the substrate (FIG. 1, 150).

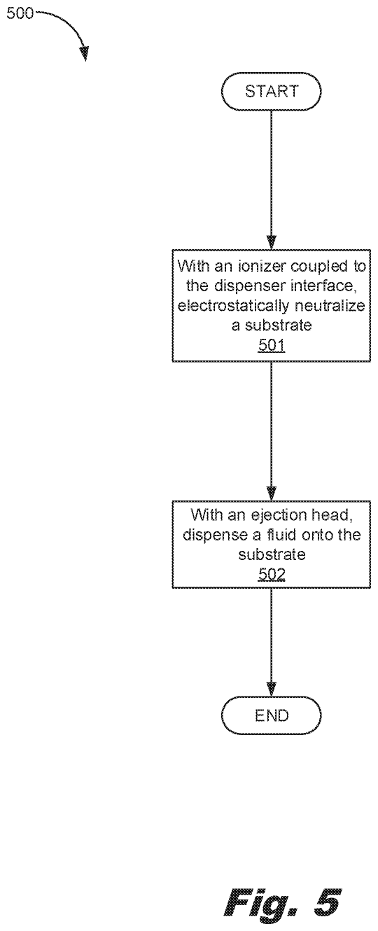

FIG. 5 is a flowchart showing a method (500) for ejecting fluid and electrostatically discharging a substrate (FIG. 1, 150) according to an example of the principles described herein. According to the method (500), an ionizer (FIG. 1, 170) coupled to the interface (FIG. 1, 102) may electrostatically neutralize (block 501) the substrate (FIG. 1, 150). In this manner, subsequent flight of the fluid from the ejection head (FIG. 3, 103) will not be altered due to electrostatic forces that may otherwise be present, and the fluid may be deposited in an intended and effectual position on the substrate (FIG. 1, 150). Immediately after, or simultaneously with, the ionizer (FIG. 1, 170) has performed an ionization routine, an ejection head (FIG. 3, 103) disposed in an interface (FIG. 1, 102) dispenses (block 502) a fluid onto a substrate (FIG. 1, 150). As described above, the substrate stage (FIG. 1, 151) and the interface (FIG. 1, 102) may move relative to one another during fluidic ejection.

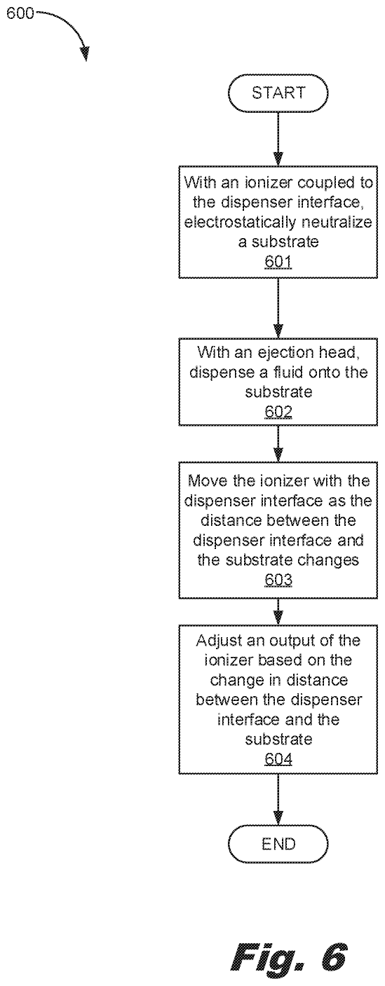

FIG. 6 is a flowchart showing a method (600) for ejecting fluid and electrostatically discharging a substrate (FIG. 1, 150). The method (600) may include electrostatically neutralizing (block 601) a substrate and dispensing (block 602) a fluid onto a substrate, which as described above may be performed in immediate sequence or simultaneously. These operations may be performed as described above in connection with FIG. 5.

In this example, the method (600) also includes moving (block 603) the ionizer (FIG. 1, 170) with the interface (FIG. 1, 102) as the distance between the interface (FIG. 1, 102) and the substrate (FIG. 1, 150) changes.

Following such movement (block 603), an output of the ionizer (FIG. 1, 170) may be adjusted (block 604). That is, an intensity, charge, or other characteristic may be altered based on a distance between the substrate (FIG. 1, 150) and the interface (FIG. 1, 102).

The systems and methods described herein provide a high-precision system for dispensing fluids onto a substrate that is less costly to manufacture and creates a more attractive price point for purchasers of fluid dispensing systems. The systems and methods described herein do so without sacrificing precision in fluid deposition onto the substrate while ensuring that the fluid is not affected by electrostatic charges of a substrate.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluid ejection device comprising;
a vertical support;
an interface movably coupled to the vertical support, the interface to receive an ejection head; and
an ionizer coupled to the interface to electrostatically neutralize a substrate.

2. The fluid ejection device of claim 1, wherein the ionizer adjusts the charge of the substrate as the ejection head in the interface dispenses a fluid onto the substrate.

3. The fluid ejection device of claim 1, wherein the ionizer is fixedly coupled to the interface.

4. The fluid ejection device of claim 1, wherein an ionization is performed by the ionizer which precedes a dispense routine performed by the ejection head.

5. The fluid ejection device of claim 1, further comprising a manual adjustment device associated with the interface to adjust a distance between the interface and the substrate.

6. The fluid ejection device of claim 1, wherein the ejection head comprises a fluidic die comprising:
a fluid ejection chamber;
an opening in the fluid ejection chamber; and
an actuator disposed within the fluid ejection chamber to eject fluid from the fluid ejection chamber through the opening.

7. A fluid ejection system comprising:
a base;
a substrate stage movably coupled to the base; and
a fluid ejection device comprising:
a vertical support extending from the base;
an interface movably coupled to the vertical support, which interface is movable in an x, y, and z direction relative to the base; and
an ionizer coupled to the interface to electrostatically neutralize a substrate on the substrate stage; and
an ejection head disposed in the interface to hold and eject fluid to be dispensed on the substrate.

8. The fluid ejection system of claim 7, wherein the ionizer is to adjust the charge of the substrate as the ejection head in the interface dispenses a fluid onto the substrate.

9. The fluid ejection system of claim 8, wherein the ionizer moves with the interface as the distance between the interface and the substrate changes.

10. The fluid ejection system of claim 9, wherein the ejection head is to perform a dispense routine concurrently as the ionizer performs an ionization routine.

11. The fluid ejection system of claim 9, wherein the ejection head comprises at least one fluidic die comprising:
a fluid ejection chamber;
an opening in the fluid ejection chamber; and
an actuator disposed within the fluid ejection chamber to eject fluid from the fluid ejection chamber through the opening.

12. The fluid ejection system of claim 11, wherein the ejection head comprises multiple fluidic die.

13. A method comprising:
electrostatically neutralizing a substrate with an ionizer coupled to an interface of a fluid ejection device; and
dispensing a fluid onto a substrate with an ejection head disposed in the interface.

14. The method of claim 13, comprising moving the ionizer with the interface as the distance between the interface and the substrate changes via a manual adjustment device associated with the interface.

15. The method of claim 14, further comprising adjusting an output of the ionizer based on the distance between the interface and the substrate.
